(19) United States
(12) Patent Application Publication
(10) Pub. No.: US 2017/0039194 A1
(43) Pub. Date: Feb. 9, 2017

(54) SYSTEM AND METHOD FOR BUNDLING DIGITIZED ELECTRONIC RECORDS

(71) Applicant: EDCO Health Information Soultions, Inc., Frontenac, MO (US)

(72) Inventor: Chez John Tschetter, Sioux Falls, SD (US)

(21) Appl. No.: 14/816,469

(22) Filed: Aug. 3, 2015

(51) Int. Cl. G06F 17/30; G06F 19/00

(52) U.S. Cl. CPC G06F 17/30011; G06F 19/322

(57) ABSTRACT

A system and method for organizing batches or groups of hard-copy documents into related sets of electronic documents is disclosed. An automatic digitizing unit can accept multiple physical documents and digitize those documents to generate electronic documents that includes electronic copies of the physical document. Machine encoded text may be generated from the electronic copy corresponding to the readable characters in the electronic document. The machine encoded text may be searched to determine whether the document is of the type to be included in a given set of electronic documents. Batches of hard-copy documents may be separated by separator documents defining the start and/or end of a group of documents. Document sets may be automatically separated into one or more sets after digitizing based on patient, physician, or other information in the documents. The electronic sets of documents may then be stored in a knowledge base for later retrieval as a single document.

### BACKGROUND

Recent cost cutting and privacy measures have changed the focus of medical records management from hard-copy paper based systems to electronic records management systems. Privacy measures like the Health Insurance Portability and Accountability Act (HIPAA) of 1996 and continued pressure to reduce costs and administrative space have created an increasing need for systems and techniques for optimizing time spent in managing records and labor costs. Paper storage costs thus pose challenges to Medical Record/Health Information Management departments to retain patient medical records in a way that allows them to be quickly retrieved for medical care or patient review, while maintaining accuracy and completeness.

Some healthcare providers have begun storing records electronically, but few have fully converted to electronic records. Regardless, paper records are still created by caregivers and must be maintained. In some cases, caregivers find it helpful to assemble and maintain multiple types of documents related to a patient so as to quickly and easily organize the most relevant information. This may be useful, for example, immediately prior to seeing a patient. However, these documents can be very diverse in content, and a document management system may be ill-equipped to organize and collate the desired set of documents in an electronic form. Associating a batch or set of physical documents in an organized and manageable way using the limited tools available in a document management system can be time consuming, labor intensive, and expensive thus potentially reducing or eliminating the advantages of converting to the use of electronic records.

### SUMMARY

Disclosed is a system and method for organizing or bundling electronic copies of physical documents as a predetermined set of documents. The system may accept input defining at least one target document to include in the “bundle” or “set” of electronic documents defined by a target document type associated with the target document. An automatic digitizing unit may automatically digitize multiple physical documents using one or more processors. The digitizing unit may be configured to generate multiple electronic documents that include digital copies of the multiple physical documents. One or more processors may be programmed or otherwise configured to recognize symbols representing document data encoded in the digital copies of the physical documents. These processors may be configured to generate machine encoded text corresponding to the symbols, and may include the document type associated with that individual document. A knowledge base may be configured to store the multiple electronic documents in the knowledge base as separate electronic records corresponding to the individual electronic documents. The separate electronic records may be separately identifiable by individual knowledge base identifiers.

The system may compare the document types of the individual electronic documents in the set of multiple documents to the target document types selected by the user. Documents matching the target document types defined by the user may be added to the set of electronic documents associated with an individual patient. The set of electronic documents associated with an individual patient may then be stored in a knowledge base as a single electronic record, the single electronic record separately identifiable by an identifier that is different than the individual knowledge base identifiers associated with the multiple electronic documents in the set. A user may then later accept input identifying a set of electronic documents associated with an individual patient and retrieve the multiple documents as a set from the knowledge base.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram illustrating components of one example of a system for bundling digitized electronic records.

FIG. 2 is a flowchart illustrating example actions that may be taken by a system like the one illustrated in FIG. 1.

FIG. 3 is a flowchart illustrating other example actions that may be taken by the system of FIG. 1.

FIG. 4 is a diagram illustrating one example of a user interface accepting input for controlling how the system of FIG. 1 bundles digitized electronic records.

FIG. 5 is a diagram illustrating another example of a user interface accepting input for controlling how the system of FIG. 1 bundles digitized electronic records.

FIG. 6 is a diagram illustrating an example of a user interface accepting input for managing and reviewing digitized documents generated by the system of FIG. 1.

FIG. 7 is a diagram of one example of a user interface that may be used in conjunction with the user interfaces in FIGS. 4-6 for accepting input defining a document type.

### DETAILED DESCRIPTION

For the purpose of promoting an understanding of the principles of the invention, reference will now be made to the examples illustrated in the drawings and specific language will be used to describe the same. It will nevertheless be understood that no limitation of the scope of the invention is thereby intended. Any alterations and further modifications in the described examples, and any further applications of the principles of the invention as described herein are contemplated as would normally occur to one skilled in the art to which the invention relates. Some examples of the invention is shown in detail, although it will be apparent to those skilled in the relevant art that some features that may not be relevant to the present invention may not be shown for the sake of clarity.

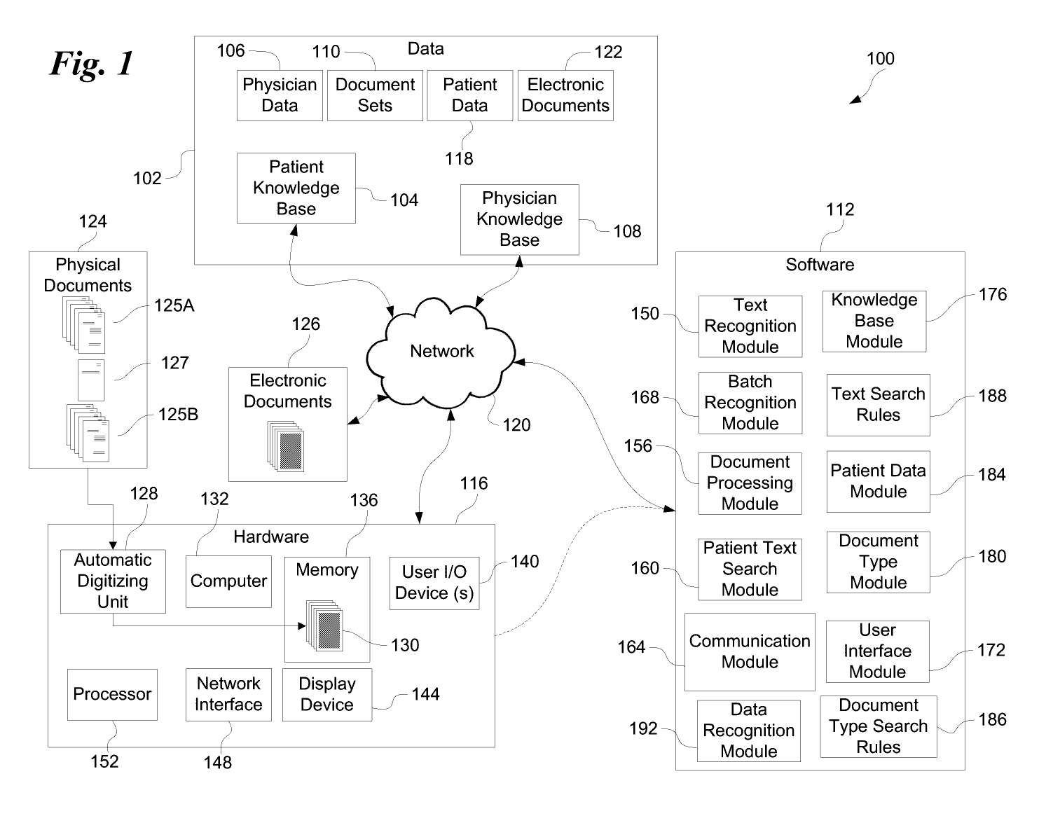

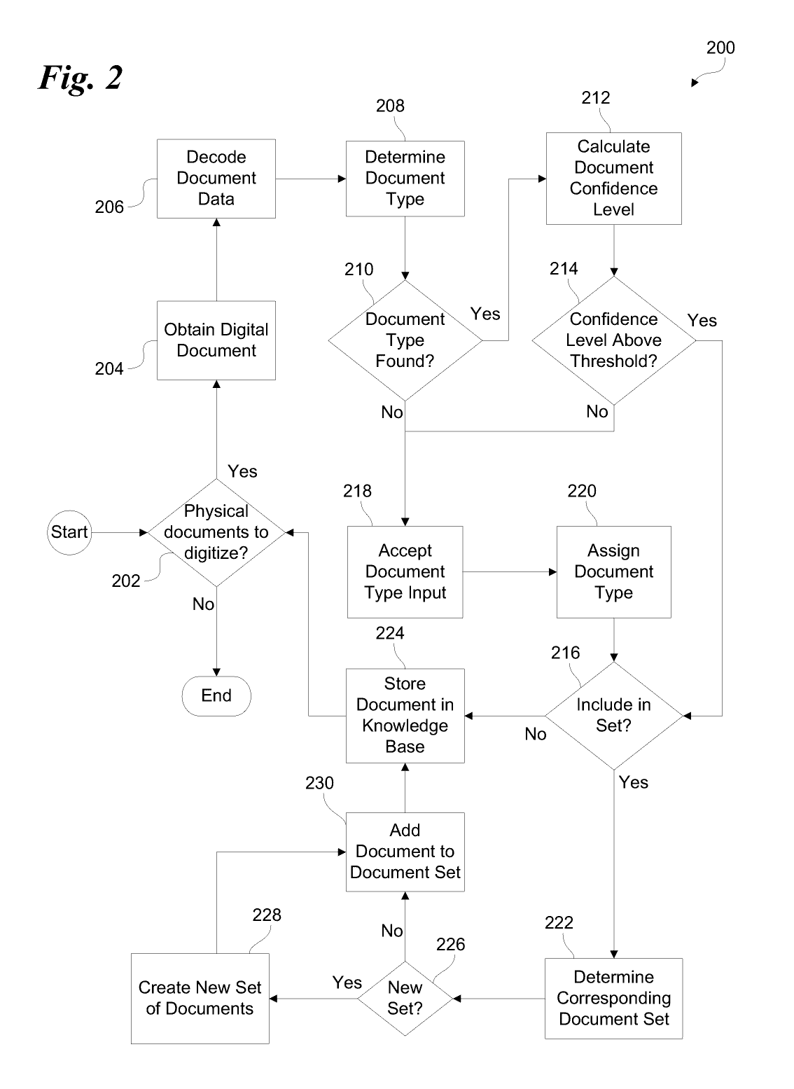

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will first appear in FIG. 1, an element identified by a “200” series reference numeral will first appear in FIG. 2, and so on. With reference to the Specification, Abstract, and Claims sections herein, the singular forms “a”, “an”, “the”, and the like include plural referents unless expressly discussed otherwise. As an illustration, references to “a device” or “the device” include one or more of such devices and equivalents thereof.

Multiple related items illustrated in the drawings with the same part number differentiated only by a letter for individual instances may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “lateral support elements 90,” or by a distinguishable portion of the full name such as “elements 90”.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples, and it is not the intent that the use of these directional terms in any manner limit the described, illustrated, and/or claimed features to a specific direction and/or orientation.

FIG. 1 illustrates at 100 an example of system components that may be included in a system for bundling patient records as disclosed herein. The system at 100 may include any suitable configuration of software, data, and hardware aspects configured to carry out the necessary functions. For example software 112 may include various aspects or modules executing on any suitable configuration of hardware 116. Software 112 and hardware 116 may access data 102 which may include data or information in the form of separate or linked data records for physicians 106, document sets 110, patients 118, and/or individual electronic documents 122. Any suitable combination of data 106, 110, 118, and 122 may be maintained in patient knowledge base 104, physician knowledge base 108, and/or any other suitable knowledge base, database, or data store.

Hardware 116 may include an automatic digitizing unit 128 that may be coupled to one or more processors 152. Digitizing unit 128 may accept physical documents 124 and it may manipulate or process them to generate one or more electronic documents 130 corresponding to the physical documents. Physical documents 124 may be optionally separated into separate batches 125A and 125B at the time they are digitized. Batches 125 may include a separator or header document 127 which may be physically positioned between batch 125A and 125B, the separator document 127 indicating when one batch 125 ends and the next begins. Separator documents 127 between batches 125 may allow a large number of documents to be processed by digitizing equipment 128 reducing or eliminating the overhead of human intervention as individual batches are processed.

In another aspect, an electronic record source 126 may provide previously digitized electronic documents. Electronic document source 126 may be any suitable system for generating and/or sending electronic documents via network 120. Document source 126 may include a digital fax queue, a directory on a local or remote server, an e-mail box, an electronic records repository operated by a third party, and the like. The system may be configured to search an electronic record source 126 for documents to process at regular intervals, or at upon input from a user, or both.

Each electronic document 130 received (irrespective of the source) may include a digital copy of a physical document 124 such as an image file representing the contents of the physical document. Acquiring documents to process may be controlled by any processor 152, or any suitable combination of processors 152. Similarly the system may include multiple automatic digitizing units 128 under the control of one or more processors 152. Data about electronic documents 130, which may include electronic documents themselves, may be stored as electronic document data 122.

Documents sets 110 may include electronic document data from multiple physical documents 124 grouped or bundled together such as in batches 125. The electronic representation of the multiple physical documents (e.g. electronic documents 130) may be accessible via data 102 as a single electronic record that includes electronic representations of multiple physical documents 124. In other words, the same document data may be accessible independently as an electronic document record 122, or as part of a set of electronic documents 110. This may result in data representing information in the same physical document 124 being stored multiple times as part of data 102. For example, the individual electronic document 130 may be accessible via an electronic document record 122 and may include an electronic representation of a physical document 124 identified by a first knowledge base identifier. A second electronic representation of the same physical document 124 may be included in a document set 110 identified by a second knowledge base identifier that is different than the first knowledge base identifier. Thus it may be possible for multiple copies of the same electronic document 130 to appear in the knowledge base identifiable as an individual document or as part of a set or bundle of electronic documents 110.

Processors 152 may be configured in any suitable arrangement in one or more computers 132 with access to any suitable number of memory devices 136. Computers 132 and processors 152 may access data 102, for example, via knowledge bases 104 and 108. Computers 132 may optionally be configured by, or programmed to execute according to software 112. Processors 152 and computers 132 may use network 120 and may access network 120 by any combination of hardware 116. For example, a network interface 148 or other suitable device may be used to interface between network 120 and processors 152. Any suitable combination of hardware 116 may be coupled to user input/output devices 140 which may be configured to accept user input and provide user output using any suitable device. A display device 144 may also be included in, or coupled to, any combination of computers 132 and processors 152. Display 144 may be controlled by processors 152 to display a user interface configured to accept input and display output related to methods or processes of organizing patient records.

Software 112 may include any suitable modules used either alone or in combination with other software. Software 112 may include a text recognition module 150 that may configure one or more processors 152 to recognize symbols representing readable characters in electronic documents 130. Text recognition module 150 may configure a processor 152 to generate machine encoded text corresponding to the recognized readable characters. In another example, one or more processors 152 may be included in automatic digitizing unit 128 and may be programmed to recognize images of characters in electronic documents 130 and automatically produce machine encoded text therefrom. Text recognition module may be characterized as, or include, Optical Character Recognition (OCR) software useful for performing the task of recognizing glyphs or figures in the electronic document that represent human readable text. The machine encoded text generated by text recognition module 150 may be searched, processed, and/or stored for processing as part of electronic document data 122. Processing may include searching the text for specific words, phrases, or specific sequences thereof.

Software 112 may include a data recognition module 192 that may configure one or more processors 152 to recognize data encoded in (or on) physical documents 124. For example, data recognition module 192 may configure one or more processors 152 to recognize and/or decode single or multi-dimensional barcodes printed on or affixed to physical documents 124. The barcodes may be digitized as part of electronic documents 130. Data recognition module 192 may configure a processor 152 to recognize the barcodes and/or decode the data encoded in any barcodes that have been detected in electronic documents 130. The data extracted from the barcodes may include identifiers that may be used to access data 102. These identifiers may correspond with patient, physician, or other data encoded in the bar code. This data may be used as a replacement for, or in addition to, any machine encoded text recognized by text recognition module 150. Data encoded in the barcode itself, or data 102 that corresponds with data in the barcode may be used for any suitable purpose by the system such as verifying the type of document, verifying or supplementing patient or physician information appearing in the electronic document 130, comparing the data to various search rules, and the like. For example, the machine encoded text from the physical document may be used together with data obtained using a barcode (either from the barcode itself, or by accessing data 102) for any further searching or verification actions taken by other software modules in software 112. Thus further processing may include searching the machine encoded text retrieved from the physical documents, as well as any barcode data when looking for words, symbols, phrases, or specific sequences thereof.

Batch recognition module 168 may be included in software 112 and may include one or more text search rules 188 for finding batch specific text indicating the batch or set of documents a particular document belongs to or is a part of. The text search rules may configure the one or more processors 152 to compare the machine encoded text in an electronic document 130 to one or more batch search rules. These rules may be configured to produce a match based on various strings of text or search patterns encoded in the rule.

Batch recognition module 168 may use or operate in conjunction with text search rules 188. The text search rules 188 may be triggered when the machine encoded text includes, exactly matches, or otherwise matches text specified in the rules. The parameters associated with the “matching” may be configured separately in rules 188. Some rules may require an exact match to satisfy the rule, while others may be “fuzzy” rules defining a set of threshold comparisons. If enough of these comparisons are satisfied, the result of the rule will indicate that the text being searched is “close enough” to be considered a match. A confidence level may be provided as part of the output from a rule 188 indicating the likelihood that the text is indeed a match according to any specific rule or set of conditions programmed in the rule. Any suitable configuration of text search rules 188 or rule comparisons may be configured to maximize the likelihood of detecting whether the physical document 124 used to create the machine encoded text relates to, or is part of, a batch of documents.

A document processing module 156 may also be included that may configure one or more processors 152 to calculate a document confidence level based on the order text. The document confidence level may be computed to indicate the likelihood that a given document matches the at least one target document type to be added to the set of electronic documents associated with an individual patient. Document processing model 156 may take into consideration in its calculations the closeness or confidence scores that may be provided by text search rules 188 used by the order text search module 152. For example, the document processing model may take the confidence levels for each rule and create an average confidence level.

A patient text search module 160 may be included that may configure one or more processors 152 to compare the machine encoded text to one or more text search rules 188 configured as patient text search rules. In this example, text search rules 188 may be configured to determine whether or not the physical document 124 from which the machine encoded text was generated includes patient information. The patient text search rules may be triggered when the machine encoded text includes the text specified in the rules. For example, patient search rules may include a comparison between the machine encoded text and a specific character string such as “name”, “patient name”, “SSN”, “MRN”, “chart”, “telephone”, “address”, and the like. A rule may be configured to search for text in predetermined patterns such as telephone numbers, Social Security numbers, postal codes, or other strings of characters that may indicate patient information is present in the electronic text. Any suitable criteria may be used to determine if the document data or machine encoded text includes patient information.

Software 112 may include a communication module 164 that may configure one or more processors 152 to automatically communicate information to interested parties such as patients, physicians, staff, and/or administrators to name a few nonlimiting examples. For example, a physician may be notified when a document set 110 is available for review. Such a notification may come in any suitable form. For example, communication module 164 may communicate with a physician directly or indirectly by any suitable means such as via a Short Message Service (SMS) message (i.e. “text message”). The communication may be sent directly to the physician, or indirectly to an assistant prepared to receive and relay the communication. Other physician communications that may occur include an email sent to an email box provided by the physician for receiving such communications. In another example, communication module 164 may configure the processor to automatically prepare and send an electronic notification to an event notification queue accessed by the physician or the physician's staff They system may optionally place an automated telephone call to the physician or the physician's office staff along with, or instead of, communications passed by other means. In another example, communication module 164 may interact with patient scheduling software to electronically attach a document set 110 or other relevant document to a new or previously established appointment recorded in the patient scheduling system allowing the physician and/or staff to have easy access to the document set for an upcoming patient visit. These are but a few nonlimiting examples. Any suitable form of communication may be used.

Software 112 may include a patient data module 184 that configures the one or more processors 152 to control computer network 120 to send a query requesting document sets 110 related to a patient identified in the machine encoded text. The query may include query parameters extracted from the document data or machine encoded text using text search rules 188. Patient data module 184 may direct the query for document sets 110 to any other suitable data repository or database that may contain document sets 110, patient data 118, or physician data 106 such as knowledge bases 104 and/or 108.

A document type module 180 may also be included in software 112. Document type module 180 may configure the one or more processors to compare the machine encoded text to one or more document type search rules 186. The comparison may be made using text search rules 188 or using a query engine that may operate as part of a knowledge base such as knowledge bases 104 or 108. For example, document type module 180 may use machine encoded text (such as text found by order text search module 152) as search criteria or query parameters in queries to a knowledge base such as patient knowledge base 104 or physician knowledge base 108. The results may include matching predetermined document types to document type text found in the machine encoded text. Document type text that may be included as search criteria includes the name of a document, a document identification code, or any other information that may identify the type of document. The document type text may be sent as query parameters to knowledge base 104 or 108 which may return results with other documents of the same or related type. A knowledge base may also be queried to return document metadata (data about a particular document type) that may be stored in the knowledge. Document type module 180 may also be configured to define new document types when new documents are digitized and processed thus adding to the predetermined set of document types known to the system.

A knowledge base module 176 may be included in software 112 that may configure the one or more processors to control a knowledge base (E.g. 104 and/or 108) to store and retrieve the one or more sets of electronic documents. The knowledge base module may, for example, configure the one or more processors to control the knowledge base to retrieve one or more individual electronic documents associated with a target patient. The one or more electronic documents may, for example, include a document type matching at least one of a preselected target document type. In another example, the batch recognition module 168 may configure the one or more processors to create a new set of electronic documents that includes the one or more electronic documents previously digitized by the automatic digitizing unit. Knowledge base module 176 may configure the one or more processors to control the knowledge base to store the new set of electronic documents in the knowledge base.

Software 112 may also include user interface module 172. User interface module 172 may configure the one or more processors 152 to accept input from a user, and/or generate or display a user interface facilitating user interaction with the system. The user interface may be displayed on display device 144 or using any other suitable user I/O device 140. For example user interface module 172 may configure a processor 152 to control a visual display device to display a user interface that includes a low confidence indicator along with controls configured to accept input from a user specifying the document type for an electronic document. The document processing module 156 may configure processors 152 to generate a low confidence indicator in the user interface when the document confidence level is below a predetermined target value. In another example, the user interface module 172 may configure the processors 152 to accept input defining at least one target patient who may be associated with a document or set of documents 124. The target patient input may include or correspond to a target patient identifier which may include any suitable identifying patient information. In another example, user interface module 172 may be configured to directly or indirectly control a display device 144 to generate a user interface on the display device that includes visual controls configured to confirm or deny that the document type associated with the document data for a corresponding digitized physical document includes a document type that is one of the predetermined set of document types accepted by a knowledge base. In yet another example, user interface module 172 may configure one or more processors 152 to accept target document input defining at least one target document identified by a document type associated with the target document. The target document may be included in a set of electronic documents.

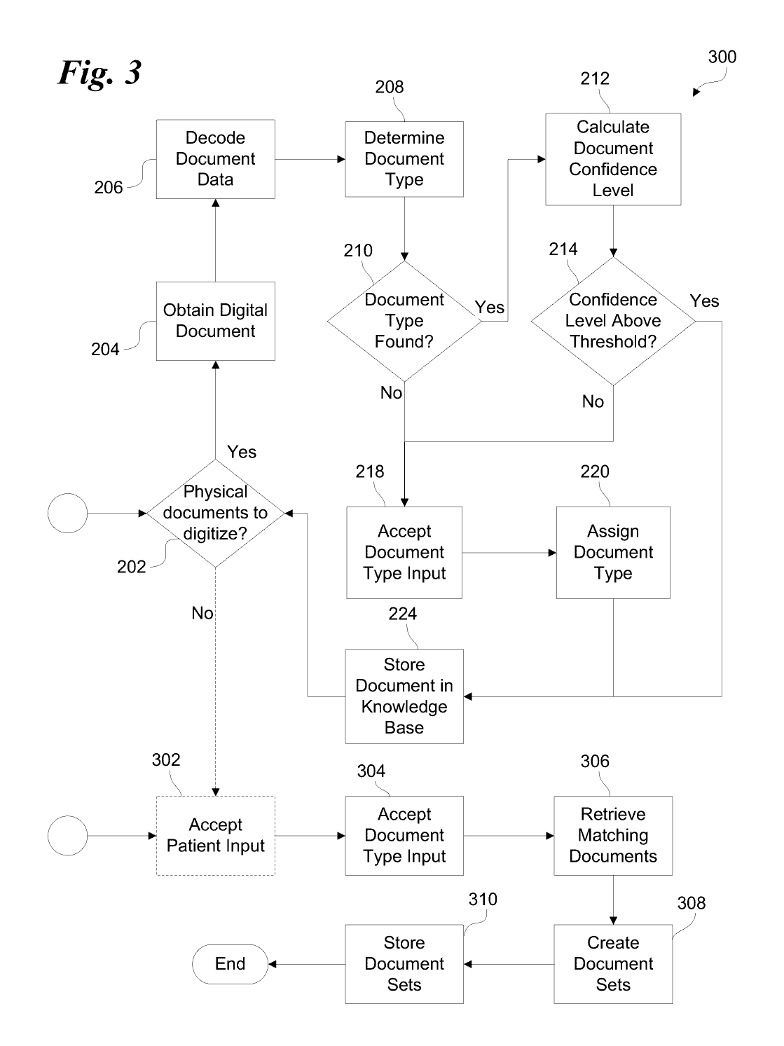

Illustrated in FIGS. 2 and 3 illustrate examples of actions a system like the system of FIG. 1 may take to “bundle” or “assemble” a packet or set of electronic documents 130. In FIG. 2 at 200 is illustrated a process for organizing the packet of electronic documents 130 as the physical documents 124 are digitized or “scanned.” In FIG. 3 at 300 is illustrated a different process for organizing the electronic documents 130 into packets after they have already been digitized.

Considering FIG. 2, the system determines whether there are any physical documents remaining to digitize at 202. At 204, one or more digital documents are obtained for processing, some or all of which may be organized in batches or sets of physical documents. These digital documents may be obtained by digitizing one or more physical documents using an automatic digitizing unit under the control of one or more processors. The digitizing unit may be configured to accept physical documents and generate an electronic document corresponding with each physical document. The electronic document may include a digital copy of the physical document.

In another example, the digital documents may be obtained or received via a computer network in digital form. The digital documents may have been produced by a computer directly without being reduced to a paper copy and then digitized. For example, an electronic records management system may forward documents directly to the system in electronic form. In another example, a physician, or staff member, or other caregiver may create an electronic document using software such as a word processor, or other document creation tool, enter the necessary information using a computer, generate a digital document, and e-mail or otherwise electronically send the document to an e-mail box, electronic notification queue, or other similar electronic collection point configured to receive digital documents. The digital document may thus be obtained by the system using a processor configured to control the network and/or electronic mail or other messaging system to obtain the digital document.

The processor may be optionally configured to decode document data encoded in the document at 206. In one example, information about the digital document such as a document type, date and time of creation, physician's name, patient's name, and the like is encoded in the document as a barcode. This barcode may have been created when the original document was created (either as a hard copy piece of paper, or electronically), or it may have been applied to the document before being presented to the system in either physical or electronic form. Decoding document data may also include configuring one or more processors to recognize symbols representing readable characters in electronic documents 130. In the process of recognizing the symbols, the processors may also generate machine encoded text from the digital copy of the physical document.

The decoded data or machine encoded text may be searched to determine a document type at 208 using one or more text search rules, document type search rules, or any other suitable method. For example, text document type search rules may configure the processor to trigger a search rule when the machine encoded text includes any text identifying the type of document. Document type text may include any strings of characters or symbols indicating that the physical document obtained at 204 may be categorized as one of an existing group of predefined document types. In another example, document type data may have been decoded by the system at 206. This document type data may be sufficient to identify the type of document, such as a result of a physician's order, a prescription, the results of a medical test or procedure, and the like. The document data may specifically include a reference to a known document type that may be used to execute queries against a knowledge base to obtain information about the document type.

If the search for a document type at 208 indicates a document type in the document at 210, a document confidence level may be calculated at 212 using the document data and any document type text it may contain and one or more processors. A document confidence level may indicate the likelihood that the document type is one of the predetermined set of one or more document types. If the confidence level is above a predetermined target or threshold at 214 the system determines whether to include the document in a set of documents at 216.

The system may also be configured to determine whether to include the current document in a set of documents at 216. The set of documents to include in a packet of documents may be determined by any suitable means. In one example, the current document type may be compared to a predetermined group of document types using any suitable processor and software such as a document processing module and/or document type search rules. If the current document type matches any of the group, the document may be added to the set. In another example, data encoded in the document may be searched and the document added to the packet of documents based on patient data, document type data, or other information in the document discovered or obtained using text search rules, document type search rules, a patient text module, or any other suitable software.

If document type information does not yield a document type recognized by the system as one of predetermined set of document types at 210, or if the confidence level calculated at 212 is below a predetermined threshold at 214, a low confidence indicator may be generated, and the one or more processors may control a display device to generate a user interface on the display device that includes the low confidence indicator. The user interface may be configured to accept document type input defining a document type. The user interface may control a display device to generate a user interface on the display device that may include visual controls. These controls may be configured to accept input confirming or denying that the document type associated with the document data for a corresponding physical document includes a document type that is one of the predetermined set of document types known to the system. This input from the user may then be assigned to the electronic document at 220.

If the document is not to be included in a set of documents at 216, the document may be stored in the knowledge base apart from any document set at 224. If the document is to be included as part of a document set, the corresponding document set is determined. Document sets may be organized any suitable way. For example, a document set may be configured to retain a predetermined set of document types for an individual patient. In another example, a set of documents may be patient specific, but only for the documents added to the system after a predetermined number of days before—such as in the last 30 days, or in the last 60 days, or the last 90 days to offer a few non-limiting examples. In another example, a document set may include all documents of a predetermined type (or types) for one or more specific physicians. This also may be limited to only documents digitized or otherwise input into the system after a predetermined time. In another example, the document set may include all documents of a particular type where the diagnosis for the patient corresponding to the document matches one or more predetermined diagnoses.

The system may determine whether a new set of documents is needed. This may be the case where physical documents are digitized in groups or batches. The batches may be defined, for example, by comparing the document data encoded in the digital copies of the physical documents with one or more separator data rules using one or more processors. A separator rule may be triggered when the document data corresponding to at least one physical document matches predetermined separator data indicating the at least one physical document is a separator document. A separator document may be a head sheet, end sheet, or other document with text, barcodes, or other data indicating a first batch is completed and a second batch of documents for a document packet is being processed. In this example, the separator document indicates that in the course of digitizing multiple physical documents, the multiple documents includes a first batch of one or more physical documents, and at least a second batch of one or more other physical documents. The separator document may be physically between the first and second batches in the multiple physical documents when the multiple physical documents are digitized by the automatic digitizing unit. The first batch of physical documents may thus correspond to a first set of electronic documents, and the second batch of physical documents may corresponds to a second set of electronic documents.

In another example, a separator data rule may be triggered indicating that a new set is needed when the document data corresponding to at least one physical document matches patient data that is different than the patient data in the previous documents processed. In this example, a separator document specifically formulated to indicate a new batch or packet of documents may not be needed or used. The system software may compare the electronic document data encoded in the digital copies of the physical documents with one or more patient data rules using the one or more processors. A patient data rule may be triggered when the document data corresponding to a physical document matches predetermined patient data indicating the patient that a physical document is associated with. The multiple physical documents may include at least a first batch of one or more physical documents with data about a first patient, and at least a second batch of one or more other physical documents with data about a second patient included therein. The first batch of physical documents may then correspond to a first set of electronic documents associated with the first patient in the knowledge base, and the second batch of physical documents corresponds to a second set of electronic documents associated with a second patient in the knowledge base. Thus multiple packets organized by patient may be created and added to without additional separator sheets.

If the system determines at 226 that a new document set is being processed, a new set is created at 228. In either case, the document under consideration may be added to the appropriate document set at 230 and added to the document knowledge base at 224. Adding a document to the document set at 230 may include using the one or more processors to control the knowledge base to store the set of electronic documents in a knowledge base as a single electronic record, the single electronic record identifiable by an identifier that is different than the individual knowledge base identifiers associated with the multiple electronic documents. The individual documents and/or the document set may be associated with a specific patient, or group of patients. Thus, one copy of the digital document may be stored in the knowledge base separately from a second copy stored in the knowledge base as part of a set of documents. Documents may be successively scanned and processed as illustrated at 200 until no physical documents remain to be digitized at 202.

FIG. 3 at 300 illustrates another example of actions a system like system 100 may take in assembling patient record packets from digitized documents. The actions illustrated in FIG. 3 are similar to actions 202-224 shown in FIG. 2 and discussed herein elsewhere. The system may digitize the physical document at 202-206, and may determine a document type (or presents a user interface for assigning one) at 208-220. The digital document may be stored in the knowledge base at 224.

After the electronic documents are stored in the knowledge base at 224, the system may be configured to accept input such as patient input at 302. Patient input may include any information identifying at least one patient such as a facility issued patient ID or MRN, a government issued ID number such as a social security number, or other identifying information. This input may be used by a processor to control the knowledge base to retrieve one or more electronic documents associated with the target patient.

The system may also be configured to accept document type input at 304 defining one or more document types to include in a packet of previously digitized documents retrievable from a knowledge base. Document type input may include selecting one or more electronic document types matching a list of predetermined document types, or it may include accepting input from the user such as in a text field allowing the user to enter a document type manually. Document type input may thus define at least one target document type that the documents in the resulting packet are to be associated with.

The one or more processors may be configured by the system to control the knowledge base to retrieve one or more electronic documents associated with the target document type or types, and/or with a patient or patients matching the patient input at 306. The one or more electronic documents retrieved from the knowledge base may include a document type matching the at least one target document type to include in the packet. The system may create a set of electronic documents at 308 that includes the one or more electronic documents retrieved using the one or more processors. The knowledge base may be controlled by the system using the one or more processors to store the set of electronic document set associated with the target patient in a knowledge base as a single electronic record at 310. Afterward, the system may accept input identifying a set of electronic documents associated with an individual patient, document type, or other criteria, and control the knowledge base to retrieve the specified set or sets of electronic documents.

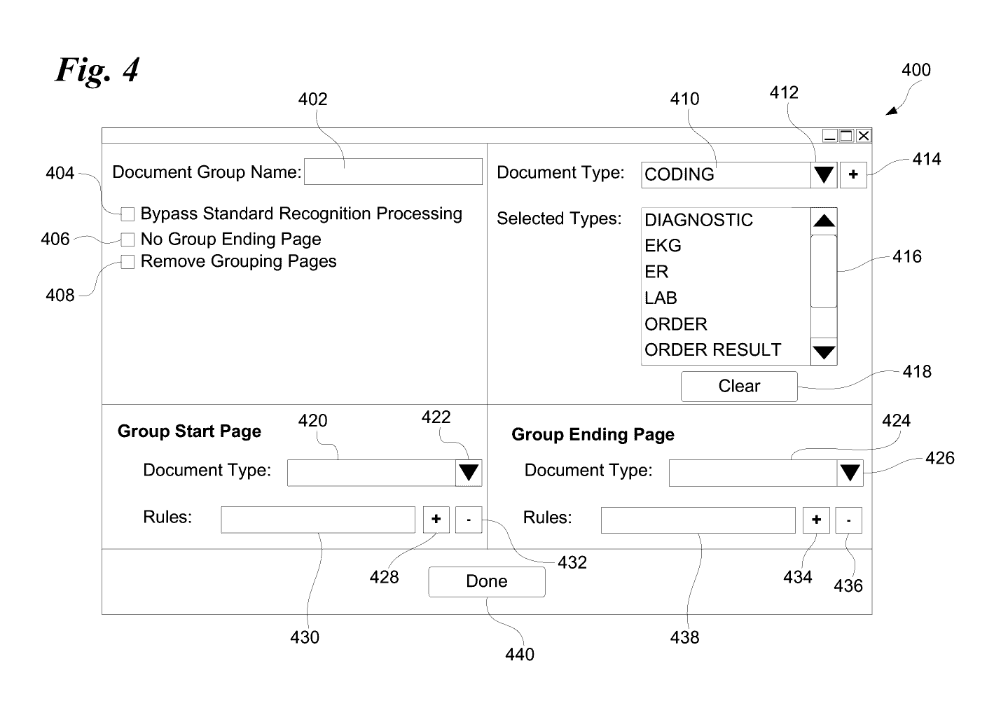

FIG. 4 at 400 illustrates one example of a user interface configured to accept input defining at least one target document to include in a set of electronic documents. A target document may be defined by one or more document types to include in the packet of electronic documents. Target documents may also be defined as any electronic documents digitized from a collection of physical documents that were positioned in the collection between a group start page and a group end page. The group start and end pages (i.e. separator documents) may be defined as specific document types or identified based on one or more rules. The documents to add to the set may be digitized after entering data in interface 400, or digitized beforehand as well.

The user interface at 400 includes a document group name field 402 configured to accept input from a user defining a group name for the set of electronic documents. The interface 400 may also include options for executing standard recognition processing at 404 (e.g. Optical Character Recognition), specifying that no page will be at the end of the group at 406, and for removing grouping (i.e. separator) pages that may have been digitized with the group of documents.

One or more document types to include in the set of electronic documents may be defined at 416. A document type selector field at 410 may be configured to accept input defining document types to include in the set illustrated at 416. The selector field 410 may accept typed manual input from a user, or a user may use an input device to open a document type search window by selecting button 412. A document type search window may be configured to accept input to find and select a document type from a predetermined group of available document types. When the user has determined the document type using selector field 410, the document type entered or selected at 410 may be added to the set of electronic documents by selecting add button 414. The selected types at 416 may be cleared by a user selecting button 418.

A group start page, or first separator page defining the start of a new batch of documents may be defined using a document type selector 420 which may be configured to accept input defining a document type. Document type selector 420 may be configured to operate like document type selector field 410. Button 422 may be configured to open a document type search window that may be configured to accept input to find and select a document type from a predetermined group of available document types. A rule for defining when a digitized document is a first separator page or group start page may be defined at 430. One or more selected rules may be added by selecting button 428, or removed by selecting button 432. Examples of rules may be any text search rule configured to be triggered when text on a separator page is found. Specific separator rules may also be used which may use text search rules, pattern searching or decoding rules for reading a bar code, or any other rules specific to a preformatted separator paged configured specifically to indicate the beginning of a batch of documents. The start page may or may not be included in the set of electronic documents depending, for example, on whether the user has selected 406 or 408.

A group end page, or second separator page defining the end of a batch of documents may be defined using a document type selector 424 which may be configured to accept input defining a document type. Document type selector 424 may be configured to operate like document type selector fields 410 and/or 420. Button 426 may be configured to open a document type search window that may be configured like button 422 accepting input to find and select a document type from a predetermined group of available document types. A rule for defining when a digitized document is a second separator page or group end page may be defined at 438. One or more selected rules may be added by selecting button 434, or removed by selecting button 436. Examples of end page separator rules may be any text search rule configured to be triggered when text on an end separator page is found. Specific separator rules may also be used which may use text search rules, pattern searching or decoding rules for reading a bar code, or any other rules specific to a preformatted separator paged configured specifically to indicate the end of a batch of documents. The end page may or may not be included in the set of electronic documents depending, for example, on whether the user has selected 406 or 408.

When selections are completed, button 440 may be actuated on the user interface by accepting user input such as a mouse click or the touch of a finger. This may also initiate the process of digitizing documents, or of selecting previously digitized documents for organization into batches or sets of electronic documents.

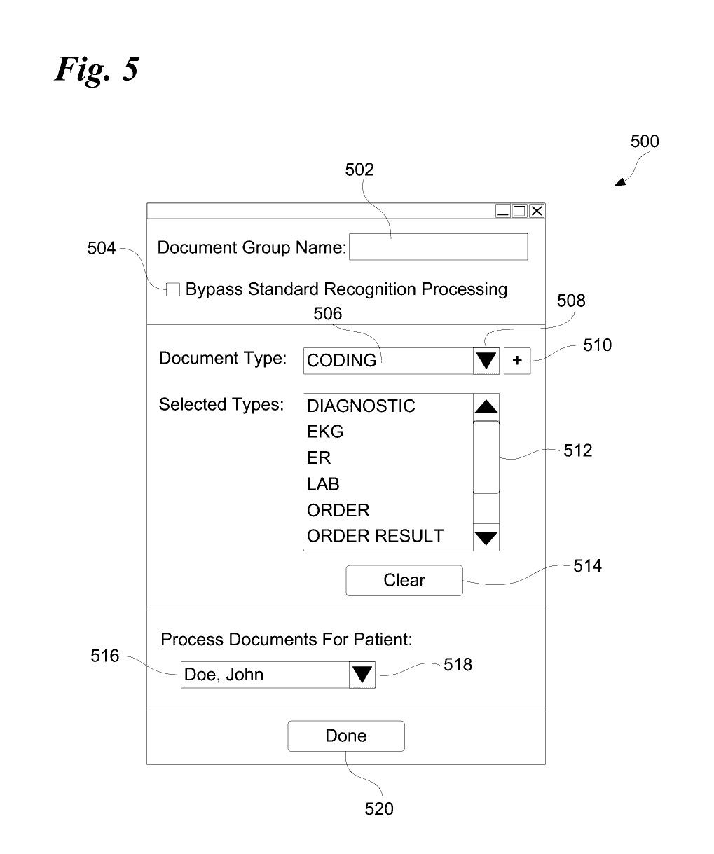

FIG. 5 illustrates at 500 another example of a user interface configured to accept input defining at least one target document to include in a set of electronic documents. The user interface at 500 may include a document group name field 502 configured to accept input from a user defining a group name for the set of electronic documents. Group name field 502 may be optionally omitted. Where a document group name is omitted, the resulting sets of electronic documents may be automatically named and associated with the patient data included in the documents. In another example, the resulting sets of electronic documents may be automatically named and associated in sets by document type. Sets of electronic documents may be automatically created and grouped by patient, by document type, by physician, by facility, by a predefined automatically incrementing batch number, by date, or by any other suitable criteria.

Like the interface at 400, interface 500 may also include options for executing standard recognition processing at 504. One or more document types to include in the set of electronic documents may be defined at 506. Like field 410 in interface 400, the document type selector field at 506 may be configured to accept input defining document types to include in the set illustrated at 512. The selector field 506 may accept typed manual input from a user, or a user may use an input device to open a document type search window by selecting button 508. A document type search window may be configured to accept input to find and select a document type from a predetermined group of available document types. When the user has determined the document type using selector field 506, the document type entered or selected at 506 may be added to the set of electronic documents by selecting add button 510. The selected types at 512 may be cleared by a user selecting button 514.

At 516, a patient selector field may optionally appear in the user interface 500 and may be configure to accept user input defining one or more patients the documents in the resulting documents sets will be associated with. A patient search window configured to access patient data in a knowledge base may be accessed by selecting button 508. Thus a user may select patient data from a predetermined list of available patients rather than manually entering text for the patient. Similar selector fields may appear in user interface 500 in addition to the patient and document type selectors configured to accept input from users defining physicians, facilities, dates, or any other suitable criteria that may be used to automatically group document sets.

When selections are completed, button 520 may be select by the user from input such as a mouse click or the touch of a finger. This may also initiate the process of digitizing documents, or of selecting previously digitized documents for organization into batches or sets of electronic documents.

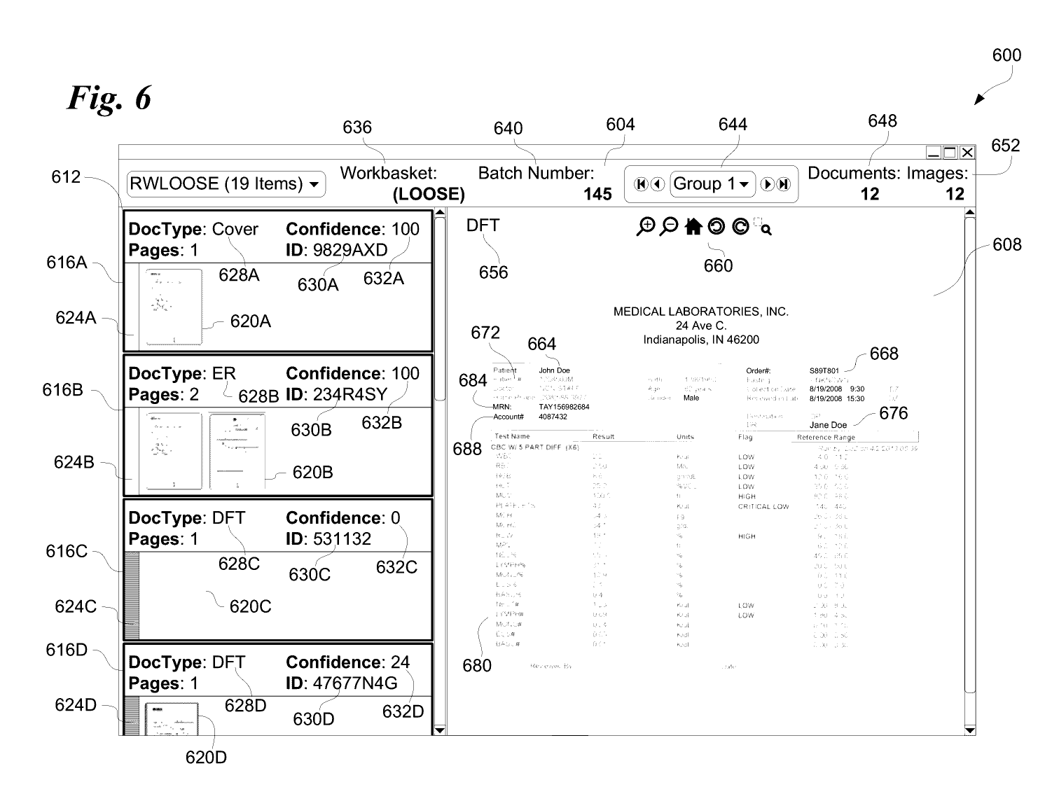

FIG. 6 illustrates at 600 an example of a user interface that may include controls accepting input from a user verifying the document type for a particular document. The user interface at 600 may also include controls configured to accept input verifying the batch or document set a particular document belongs to. The user interface may include a control panel 604, a document image viewer at 608, and a summary panel 612 for viewing digitized documents being reviewed. Control panel 604 may include various indicators for managing groups of documents digitized by an automatic digitizing system or device. Documents may be organized by work baskets 636, and/or by batch number 640. Groups of documents may be selected using a group selector 644, and the number of documents may be displayed at 648 as well as the number of images to review at 652.

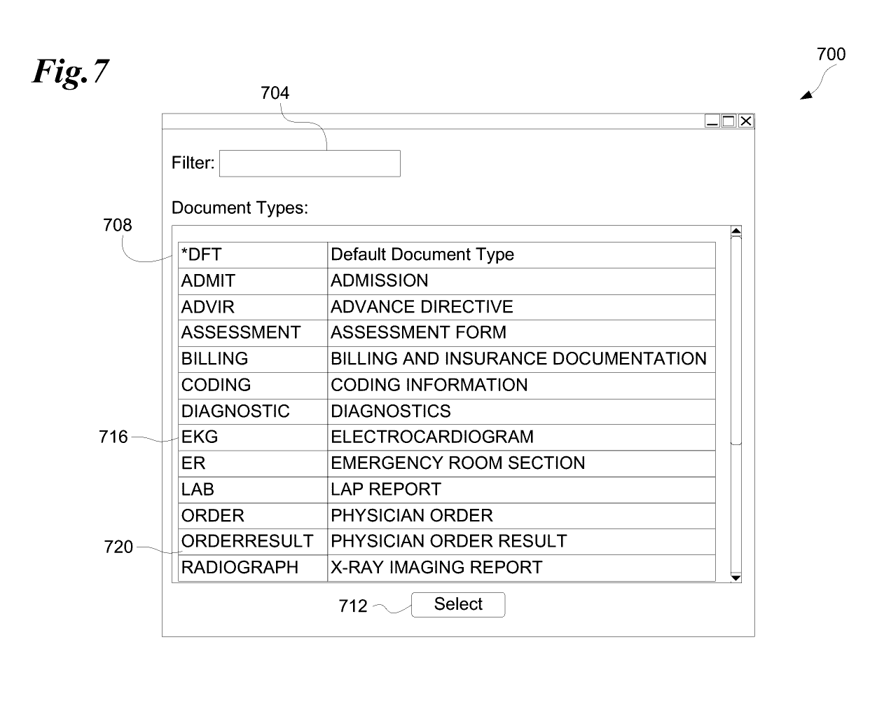

Summary panel 612 may include separate document summary views 616 for each electronic document 130 digitized at 204 (see FIG. 2). The summary view 616 may include a document type 628 indicating the type of document under review. In one example, the document type 628 may be automatically populated by searching machine encoded text corresponding to recognizable symbols representing readable characters in the original physical document. If this search of the machine encoded text results in a confidence level 632 that is above a target threshold, the system may automatically determine the document type. In another example, document type 628 may be obtained from encoded data in the document, such as data encoded in a barcode. Otherwise the document type may be determined by user input selecting a document type from a user interface displaying a predetermined set of document types (See FIG. 7 and discussion below).

The summary may further include a small or “thumbnail” image 620 of the electronic document displayed in the image viewer 608, and an identifier at 630. The confidence level indicators 632 and 624 may indicate the likelihood that the document includes the document type 628. Confidence level indicator 632 may appear as a numerical value while indicator 624 may be represented as a color-coded bar or icon. In one example, indicators 624 may appear as a blank or colored indicator (e.g. green) when the confidence level 632 is above a predetermined threshold target. Indicators 624 may appear as other icons or in a different color (e.g. red) if the confidence level 632 is below a predetermined threshold or target value. Any suitable indicia, text, color coding, icon, symbol, visual pattern or other indicator may be used to indicate when the confidence level is above or below a predetermined value.

For example, the system determined that the document shown at 616A is a “cover” sheet or separator document as shown at 628A with a confidence level of 100 (e.g. the highest confidence level possible). In another example shown at 616C, the document type 628C could not be determined and is left at a default value “DFT” with a corresponding confidence level of 0 at 632C. Confidence indicator 624C may appear shaded or colored in this example to indicate the document type could not be determined. The document summary shown at 616D is similar in that the document type could not be determined with a sufficient confidence level which results in confidence indicators 624D and 632D indicating a low confidence.

Document image viewer 608 may accept input in conjunction with information displayed in summary views 616. Summary views 616 may accept input from a user selecting a document. This input may be accepted using any suitable input device such as a pointing device or a keyboard. The document indicated in the selected summary 616 may then be shown with additional detail in document viewer 608 as illustrated in FIG. 6.

As illustrated in FIG. 6, document 616C has been selected and appears in image viewer 608. As illustrated, the document is the result of a physician's order. In this example, order search rules were not triggered causing a low confidence level 632C. Put another way, the text search rules applied to the machine encoded text obtained from the electronic document could not be matched to any text or insufficient encoded data was obtained from the document as well. Thus the system was unable to determine that the electronic document displayed at 608 is a laboratory report ordered by a physician, and is thus the result of a physician's order.

Image viewer 608 allows the user to visually inspect the electronic document 130. Viewer 608 may accept input from a user engaging various image related functions. For example, a user may select any of icons 660 to zoom in, zoom out, rotate clockwise, rotate counterclockwise, zoom into a selected area, or return to a full-size view.

Various electronic documents containing patient, order, physician, and any other information may be displayed in viewer 608. The electronic document may include information such as patient name 664, physician information 676, and information specific to the result of the physician's order at 680. Identifying information may also include an order number 668, a patient number 672, a medical record number 684, and/or an account number 688. The current document type may also be displayed at 656. The user may review the electronic document displayed in viewer 608 and may use any of the information displayed in the document to verify patient, physician, order information, document type, and/or that the document is the result of a physician's order.

If a document type could not be automatically determined by the system (see 628C and 628D), or if a user provides input requesting to select one of the available document types (see buttons 412 or 508), the system may provide a user interface for accepting input from a user selecting or otherwise defining a document type and associating it with an electronic document being reviewed, or with a list of selected types (such as 416 and 512).

An example of a document type search and or selection user interface appears in FIG. 7 at 700. A text entry field 704 may be provided and configured to accept text input from a user. For example, the user interface at 700 may accept characters entered by a user using an input device. The user interface may be configured to initiate a search for available document types matching characters entered by a user before, during, and/or after the user has begun entering characters into text entry field 704. Any matching document types found in a search may be shown in a document type selection window 708. Window 708 may be configured to accept selection input such as from a pointing device manipulated by user. The user's selection input may be used to update the document type for the corresponding electronic document as shown in FIG. 6, or to add to a list of selected document types in FIGS. 4 and 5. User input may be accepted selecting “order result” 720 from the current document types shown in window 708. The selection may be confirmed when the user interface accepts input via a select button 712.

The concepts illustrated and disclosed herein may be configured according to any of the following numbered non-limiting examples:

### Example 1

A method, comprising using the one or more processors to accept input defining at least one target document to include in a set of electronic documents, wherein the at least one target document is defined by a target document type associated with the target document;
controlling an automatic digitizing unit to automatically digitize multiple physical documents using one or more processors, wherein the digitizing unit is configured to generate multiple electronic documents that include digital copies of the multiple physical documents;
using the one or more processors to recognize symbols representing document data encoded in the digital copies of the physical documents, wherein the one or more processors are configured to generate machine encoded text corresponding to the symbols, and wherein the document data includes the document type associated with that individual document;
using the one or more processors to control the knowledge base to store the multiple electronic documents in the knowledge base as separate electronic records, wherein the separate electronic records correspond to the individual electronic documents of the multiple electronic documents, wherein the separate electronic records are identified by individual knowledge base identifiers, and wherein the document type included in the document data is associated with the individual electronic records in the knowledge base;
comparing the document type of individual electronic documents of the multiple electronic documents to the at least one target document type using the one or more processors, wherein target documents from the multiple electronic documents matching the at least one target document type are added to the set of electronic documents associated with an individual patient;
using the one or more processors to control the knowledge base to store the set of electronic documents associated with an individual patient in a knowledge base as a single electronic record, the single electronic record identifiable by an identifier that is different than the individual knowledge base identifiers associated with the multiple electronic documents; and
using the one or more processors to accept input identifying a set of electronic documents associated with an individual patient, wherein the one or more processors controls the knowledge base to retrieve the set of electronic documents.

### Example 2

The method of any preceding example, further comprising comparing the document data encoded in the digital copies of the physical documents with one or more separator data rules using the one or more processors, wherein a separator rule is triggered when the document data corresponding to at least one physical document matches predetermined separator data indicating the at least one physical document is a separator document;
wherein the multiple physical documents include at least a first batch of one or more physical documents, and at least a second batch of one or more other physical documents;
wherein the separator document is between the first and second batches in the multiple physical documents when the multiple physical documents are digitized by the automatic digitizing unit; and
wherein the first batch of physical documents corresponds to a first set of electronic documents, and the second batch of physical documents corresponds to a second set of electronic documents.

### Example 3

The method of any preceding example, further comprising comparing the document data encoded in the digital copies of the physical documents with one or more patient data rules using the one or more processors, wherein a patient data rule is triggered when the document data corresponding to at least one physical document matches predetermined patient data indicating the patient that a physical document is associated with;
wherein the multiple physical documents include at least a first batch of one or more physical documents with data about a first patient included therein, and at least a second batch of one or more other physical documents with data about a second patient included therein; and
wherein the first batch of physical documents corresponds to a first set of electronic documents associated with the first patient in the knowledge base, and the second batch of physical documents corresponds to a second set of electronic documents associated with a second patient in the knowledge base.

### Example 4

The method of any preceding example, further comprising comparing the document data to one or more document type search rules using the one or more processors, wherein a document type search rule is triggered when the document data matches one of a predetermined set of one or more document types;
wherein the matching document type matched by the triggered document type search rule is associated with the document data.

### Example 5

The method of any preceding example, comprising calculating a document confidence level using the document data and the one or more processors, wherein the document confidence level indicates the likelihood that the document type is one of the predetermined set of one or more document types;

### Example 6

The method of any preceding example, comprising generating a low confidence indicator using the one or more processors, wherein the low confidence indicator indicates that the document confidence level is below a predetermined target value;
using the one or more processors to control a display device to generate a user interface on the display device, the user interface including controls configured to confirm or deny that the document type associated with the document data for a corresponding physical document includes a document type that is one of the predetermined set of document types.

### Example 7

The method of any preceding example, wherein documents from the multiple electronic documents not matching at least one of the predetermined set of one or more document types are not added to the set of electronic documents.

### Example 8

A method, comprising using one or more processors to control an automatic digitizing unit coupled to the one or more processors, wherein the digitizing unit is configured to accept multiple physical documents, and wherein the digitizing unit generates multiple electronic documents that include digital copies of the multiple physical documents;
using the one or more processors to recognize symbols representing document data encoded in the digital copies of the physical documents, wherein the one or more processors are configured to generate machine encoded text corresponding to the symbols, and wherein the machine encoded text includes a document type;
using the one or more processors to control the knowledge base to store the multiple electronic documents in the knowledge base as separate electronic records, wherein the separate electronic records correspond to the individual electronic documents of the multiple electronic documents, wherein the separate electronic records are identified by individual knowledge base identifiers, and wherein the individual electronic records are associated with the at least one corresponding document type in the knowledge base;
after the multiple electronic documents are stored in the knowledge base, using the one or more processors to accept input defining at least one target document to include in a set of electronic documents, wherein the at least one target document is defined by a target document type associated with the target document;
using the one or more processors to accept input defining at least one target patient;
using one or more processors to control the knowledge base to retrieve one or more electronic documents associated with the target patient, wherein the one or more electronic documents include a document type matching the at least one target document type;
creating a set of electronic documents that includes the one or more electronic documents using the one or more processors;
controlling the knowledge base using the one or more processors to store the set of electronic documents associated with the target patient in a knowledge base as a single electronic record; and
using the one or more processors to accept input identifying a set of electronic documents associated with an individual patient, wherein the one or more processors controls the knowledge base to retrieve the set of electronic documents.

### Example 9

The method of example 8, further comprising comparing the document data encoded in the digital copies of the physical documents with one or more separator data rules using the one or more processors, wherein a separator rule is triggered when the document data corresponding to at least one physical document matches predetermined separator data indicating the at least one physical document is a separator document;
wherein the multiple physical documents include at least a first batch of one or more physical documents, and at least a second batch of one or more other physical documents;
wherein the separator document is between the first and second batches in the multiple physical documents when the multiple physical documents are digitized by the automatic digitizing unit; and
wherein the first batch of physical documents corresponds to a first set of electronic documents, and the second batch of physical documents corresponds to a second set of electronic documents.

### Example 10

The method of any one of examples 8 or 9, further comprising comparing the machine document data encoded in the digital copies of the physical documents with one or more patient data rules using the one or more processors, wherein a patient data rule is triggered when the document data corresponding to at least one physical document matches predetermined patient data indicating the patient that a physical document is a associated with;
wherein the multiple physical documents include at least a first batch of one or more physical documents with a first patient data included therein, and at least a second batch of one or more other physical documents with a second patient data included therein; and
wherein the first batch of physical documents corresponds to a first set of electronic documents associated with the first patient in the knowledge base, and the second batch of physical documents corresponds to a second set of electronic documents associated with a second patient in the knowledge base.

### Example 11

The method of any one of examples 8 through 10, further comprising comparing the document data to one or more document type search rules using the one or more processors, wherein a document type search rule is triggered when the document data matches one of a predetermined set of one or more document types;
wherein the matching document type matched by the triggered document type search rule is associated with the document data.

### Example 12

The method of any one of examples 8 through 11, comprising calculating a document confidence level using the document data and the one or more processors, wherein the document confidence level indicates the likelihood that the document type is one of the predetermined set of one or more document types.

### Example 13

The method of any one of examples 8 through 12, comprising generating a low confidence indicator using the one or more processors, wherein the low confidence indicator indicates that the document confidence level is below a predetermined target value;
using the one or more processors to control a display device to generate a user interface on a display device, the user interface including controls configured to confirm or deny that the document type associated with the document data for a corresponding physical document includes a document type that is one of the predetermined set of document types.

### Example 14

A system, comprising one or more computers having one or more processors and at least one memory;
a patient knowledge base;
a computer network coupling the one or more computers to the patient knowledge base;
an automatic digitizing unit controlled by the one or more processors, wherein the automatic digitizing unit is configured to accept a physical document and generate an electronic document that includes a digital copy of the physical document, the digital copy including document data;
a text recognition module that configures the one or more processors to recognize symbols representing readable characters in the digital document and generate machine encoded text corresponding to the readable characters;
a user interface module that configures the one or more processors to accept target document input defining at least one target document identified by a target document type associated with the target document to include in a set of electronic documents, and/or target patient input defining a target patient the at least one target document is associated with, the target patient input corresponding to a target patient identifier;
a document type module that configures the one or more processors to compare the machine encoded text to one or more document type search rules, wherein the one or more processors triggers a document type search rule when the machine encoded text includes document type text;
a batch recognition module that configures the one or more processors to separate multiple digital copies of corresponding physical documents in to one or more sets of electronic documents;
a document processing module that configures the one or more processors to calculate a document confidence level, wherein the document confidence level indicates the likelihood that the document includes a document type that is one of a set of predetermined document types; and
a knowledge base module that configures the one or more processors to control the patient knowledge base to store and retrieve the one or more sets of electronic documents.

### Example 15

The system of claim 14, wherein the batch recognition module is configured to compare the document data encoded in the digital copies of the physical documents with one or more separator data rules using the one or more processors, wherein a separator rule is triggered when the document data corresponding to at least one physical document matches predetermined separator data indicating the at least one physical document is a separator document;
wherein the multiple physical documents include at least a first batch of one or more physical documents, and at least a second batch of one or more other physical documents;
wherein the separator document is between the first and second batches in the multiple physical documents when the multiple physical documents are digitized by the automatic digitizing unit; and
wherein the first batch of physical documents corresponds to a first set of electronic documents, and the second batch of physical documents corresponds to a second set of electronic documents.

### Example 16

The system of any one of examples 14 and 15, comprising a patient text search module that configures the one or more processors to compare the machine encoded text to one or more patient text search rules, wherein the one or more processors triggers a patient text search rule when the machine encoded text includes patient text identifying a patient;
wherein the patient text search module is configured to compare the document data encoded in the digital copies of the physical documents with one or more patient data rules using the one or more processors;
wherein a patient data rule is triggered when the document data corresponding to at least one physical document matches predetermined patient data indicating the patient that a physical document is associated with;
wherein the multiple physical documents include at least a first batch of one or more physical documents with a first patient data included therein, and at least a second batch of one or more other physical documents with a second patient data included therein; and
wherein the patient text search module communicates with the batch recognition module, the batch recognition module configured to store a first batch of electronic documents corresponding to a first set of physical documents associated with the first patient in the knowledge base, and a second batch of electronic documents corresponding to a second set of physical documents associated with a second patient in the knowledge base.

### Example 17

The system of any one of examples 14 through 16, comprising an input device coupled to the one or more processors and configured to accept input from a user, wherein the interface module configures the one or more processors to accept input from the input device verifying that one or more electronic documents are including in a set of electronic documents.

### Example 18

The system of any one of examples 14 through 17, wherein the user interface module configures the one or more processors to control a visual display device to display a user interface;
wherein the user interface includes a low confidence indicator, and visual controls configured to accept input from a user specifying the document type for an electronic document; and
wherein the document processing module configures the one or more processors to generate a low confidence indicator in the user interface when the document confidence level is below a predetermined target value.

### Example 19

The method of any one of examples 14 through 18, wherein the document processing module is configured to compare the document data to one or more document type search rules using the one or more processors, wherein a document type search rule is triggered when the document data matches one of a predetermined set of one or more document types.

### Example 20

The system of any one of examples 14 through 19, wherein the user interface module configures the one or more processors to accept input defining at least one target document type to include in a set of electronic documents;
wherein the user interface module configures the one or more processors to accept input defining at least one target patient;
wherein the knowledge base module configures the one or more processors to control the knowledge base to retrieve one or more individual electronic documents associated with the target patient, wherein the one or more electronic documents include a document type matching the at least one target document type; and
wherein the batch recognition module configures the one or more processors to create a new set of electronic documents that includes the one or more electronic documents previously digitized by the automatic digitizing unit; and
wherein the knowledge base module configures the one or more processors to control the knowledge base to store the new set of electronic documents in the knowledge base.

### Glossary of Definitions and Alternatives

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's and Random House dictionaries. As used in the specification and claims, the following definitions apply to the following terms or common variations thereof (e.g., singular/plural forms, past/present tenses, etc.):
“Automatic Digitizing Unit” or “scanner” generally refers to a device configured to create a digital or electronic document. An automatic digitizing unit may be characterized as an input device when coupled to a computer. The unit may pass the electronic document to the computer automatically when digitizing is complete. An automatic digitizing unit may also be characterized as software for generating or creating electronic documents.
Examples of automatic digitizing units include document scanners that may have document feeders configured to pass a document through the device and capture a digital representation of the document in the process. Units of this type may be capable of scanning many pages of multiple physical documents. Some may capture up to 10, up to 50, up to 150, or more pages per minute. An automatic digitizing unit may capture the physical documents as grayscale images, color images, or black and white representations. The device may also digitize both sides of double-sided document at the same time. Some digitizing units may include software that configures the scanner to eliminate additional stains or accidental marks, smudges, or other artifacts present in the digital copy of the original physical document.
While paper feeding and digitizing can be done automatically and quickly, preparing the documents for capture and indexing the resulting electronic documents may require much work by humans. Preparation may involve manually inspecting the physical documents to ensure they are in order, unfolded, without staples or anything else that might jam the unit. Additionally, identifying marks, such as bar codes, QR codes, identifying numbers or strings of text, and the like may be applied for identifying a document.
Examples of automatic digitizing units include, but are not limited to, flatbed scanners, document scanners (with or without automatic document feeders), camera scanners, smart phones executing a scanning app, drum scanners, film scanners, roller scanners, and hand-held scanners. These devices may be coupled to a controlling computer by physical connectors such as wires, optical fibers, and the like, or by way of a wireless network connection.
In another aspect, software for generating electronic documents may also be characterized as an automatic digitizing unit. For example, word processing software may be used to generate the document in an electronic form which may be transmitted over network. The word processing software may therefore be considered an “automatic digitizing unit” because it is configured to generate electronic or digital documents that may include machine encoded text, images of human readable characters or glyphs, or barcodes encoding various data into the electronic document.
“Barcode” generally refers to a visible arrangement of shapes, colors, lines, dots, or symbols fixed in some medium and arranged on the medium in a pattern configured to encode data. Examples include optical machine-readable representations of data relating to an object to which the barcode is attached such as a Universal Produce Code (UPC), or any visible patterns related to any type of Automatic Identification and Data Capture (AIDC) system. Another example of a barcode is a Quick Response Code (QR Code) which arranges various light and dark shapes to encode data.
Any suitable medium is envisioned. Examples include an adhesive label, a physical page, a display device configured to display the barcode, or any other object such as a box, a statute, a machine, or other physical structure to which the barcode is affixed or upon which it is printed. For example, a bar code may be etched into metal, machined into plastic, or formed by organizing visible three-dimensional shapes into a pattern.
The barcode may not be visible to humans but may be fixed using a substance or device that allows the barcode to be visible to sensors in a machine configured to read wavelengths of light outside those detectable by the human eye. Examples of this type of barcode include barcodes printed with ink that is only visible under ultraviolet (i.e. “black”) light, or barcodes displayed using infrared light.
“Character Recognition” or “Optical Character Recognition” (OCR) generally refers to a mechanical, electronic, or software process by which symbols or glyphs are automatically recognized by a computer or other machine and converted to machine encoded text that corresponds to the readable characters. The symbols may be readable characters discernable on a physical object or by processing an electronic document. Images of printed text maybe captured by a scanner or automatic digitizing unit and then later optically recognized by a computer or other machine device operating OCR software or hardware. The machine encoded text can be electronically edited, searched, stored in a memory or similar device, displayed on a visual display, and used in machine processes such as machine translation, text-to-speech translation, and text data mining. Character recognition may also be performed by directly scanning a three-dimensional object to capture text from the object.
Matrix matching is one method of performing OCR. It includes comparing a digitized image of a document to a stored glyph pixel-by-pixel sometimes referred to as “pattern matching”, “pattern recognition”, or “image correlation”. Input glyphs may need to be correctly isolated from the rest of the image, and stored in a similar font and at the same scale for this technique to be successful. Another example method of performing OCR is by feature extraction which decomposes glyphs into “features” (e.g lines, closed loops, line direction, and line intersections). Features are compared with abstract vector-like representation of a character, to choose the closest match.
“Computer” generally refers to any computing device configured to compute a result from any number of input values or variables. A computer may include a processor for performing calculations to process input or output. A computer may include a memory for storing values to be processed by the processor, or for storing the results of previous processing.
A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.
A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus a computer may include one or more physical processors or other computing devices or circuitry, and may also include any suitable type of memory.
A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.
The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.
A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.
Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.
“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of floors in a house.
Data may be organized and represented in a structured format. Examples include a tabular representation using rows and columns, a tree representation with a set of nodes considered to have a parent-children relationship, or a graph representation as a set of connected nodes to name a few.
The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.
“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data). The DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.
Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, the “object-relational” model, the “file”, “indexed file” or “flat-file” models, the “hierarchical” model, the “network” model, the “document” model, the “XML” model using some variation of XML, the “entity-attribute-value” model, and others.
Examples of commercially available database management systems include PostgreSQL provided by the PostgreSQL Global Development Group; Microsoft SQL Server provided by the Microsoft Corporation of Redmond, Wash., USA; MySQL and various versions of the Oracle DBMS, often referred to as simply “Oracle” both separately offered by the Oracle Corporation of Redwood City, Calif., USA; the DBMS generally referred to as “SAP” provided by SAP SE of Walldorf, Germany; and the DB2 DBMS provided by the International Business Machines Corporation (IBM) of Armonk, N.Y., USA.
The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.
“Display device” generally refers to any device capable of being controlled by an electronic circuit or processor to display information in a visual or tactile. A display device may be configured as an input device taking input from a user or other system (e.g. a touch sensitive computer screen), or as an output device generating visual or tactile information, or the display device may configured to operate as both an input or output device at the same time, or at different times.
The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback (or a suitable replacement therefor such as in the case of a blind person) to a user using a system. Display devices may also include a “check engine” light, a “low altitude” warning light, an array of red, yellow, and green indicators configured to indicate a temperature range to name a few additional non-limiting examples.
“Document Type” generally refers to any classification assigned to a document. This classification may be indicated by any suitable arrangement of markings, symbols, barcodes or other distinguishing indicia. Document type may be characterized as part of a document's meta data, and a single document may be classified using more than one document type.
“Electronic Document” or “Digital Document” generally refers to a collection of digital bits maintained together as a unit. The collection may be maintained in an electronic file and may be associated with a particular software application or encoding scheme useful for rendering the contents of the document, either in a physical form (e.g. printed on paper), or in an electronic form (e.g. displayed on a display device).
The collection of bits may have been generated using a compression algorithm thus compressing the size of the file and reducing the number of bits before digitizing process is completed. Examples of compressed or uncompressed file types (encoding schemes) include, but are not limited to, Joint Photographic Experts Group (JPEG), Tagged Image File Format (TIFF), Portable Document Format (PDF), Portable Network Graphics (PNG) format, and Graphics Interchange Format (GIF).
“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.
“Machine Encoded Text” generally refers to a computer generated or computer readable collection of bits organized using a character encoding scheme. The character encoding scheme can define how arrangements of bits in the collection correspond to recognizable characters or symbols. Such characters or symbols may include the glyphs or symbols in a human language alphabet. Examples of character encoding schemes useful for machine encoded text include the American Standard Code for Information Interchange (ASCII), Unicode, Universal Character Set (UCS), and any of the various universal character set encodings schemes such as the Universal Character Set+Transformation Format-8 Bit (UTF-8).
“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).
Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).
Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.
“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.
Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.
“Multiple” as used herein is synonymous with the term “plurality” and refers to more than one, or by extension, two or more.
“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.
Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.
Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.
Cellular network standards may use various channel access methods such as FDMA, TDMA, CDMA, or SDMA. Different types of data may be transmitted via different links and standards, or the same types of data may be transmitted via different links and standards.
The geographical scope of the network may vary widely. Examples include a body area network (BAN), a personal area network (PAN), a local-area network (LAN), a metropolitan area network (MAN), a wide area network (WAN), or the Internet.
A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.
A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.
“Order” generally refers to a physical or electronic document initiated by a physician on behalf of a patient indicating a course of treatment for the patient. Types of orders include standing orders, which may include specific treatment protocols. These protocols may be elaborate with multiple steps and may include testing throughout the treatment. Standing orders are generally conditioned upon the occurrence of certain clinical events. With standing orders, generally all patients who meet the criteria for the order receive the same treatment. For example, a standing order may be in place in a public health clinic for the treatment of specific diseases that occur often. Standing orders may be in place prescribing a drug protocol of antibiotics for specific bacterial infections. Once the specific disease is identified, a nurse may administer the antibiotics as specified by the protocol and authorized by the physician directing the clinic. A record of the treatment protocol will be entered in the patient's records but a copy of the order may not be included.
Preprinted orders are orders that a physician may use repeatedly and therefore may have photocopied to save the inconvenience and potential errors of rewriting the order each time it is needed. Although the orders are the same for all patients, they are not standing orders because they are not conditional. The physician, not a nurse, determines whether the printed orders will be used in a given case. Unlike a standing order, treatment is not initiated until the physician incorporates the printed order into the chart. Preprinted orders may include variations approved by the physician and noted in the patient's medical records.
Direct orders are generally voice orders given directly to non-physician personnel. Sometimes these orders are documented in the medical records, but many are carried out at once and may not be recorded. For example, when a surgeon directs an operating room nurse assisting in a procedure, some of the surgeon's orders will be documented, but most will not. The satisfactory completion of the work performed as a result of the order will be documented as part of the patient's medical records.
“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.
“Patient” generally refers to a person or animal who is, or has been, a recipient of advice, diagnosis, and/or treatment of disease, injury, or any physical and/or mental ailment or disorder.
“Personal computing device” generally refers to a computing device configured for use by individual people. Examples include mobile devices such as Personal Digital Assistants (PDAs), tablet computers, wearable computers installed in items worn on the human body such as in eye glasses, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.
“Physician” generally refers to a person who has acted (or continues to act) to remedy an ailment experienced by that person or another, or to create a helpful result after something unpleasant has occurred related to a person's health. Any individual offering, treatment, advice, or care for promoting, maintaining or restoring human health through the study, diagnosis, and/or treatment of disease, injury, and other physical and mental impairments may be considered a “physician.” This includes those who are officially licensed to practice medicine in any general or specialized area of medicine, as well as various types of “unlicensed” healthcare practitioners, and any assistants, staff, or other support personal thereof. Examples include, but are not limited to, medical doctors, surgeons, nurses, nurse practitioners, psychiatrists, emergency medical technicians, paramedics, fire fighters, military personnel, teachers, professors, nutritionists, homeopathic doctors, faith healers, and the like.
“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, Calif., USA. Other examples of commercially available processors include but are not limited to the X8 and Freescale Coldfire processors made by Motorola Corporation of Schaumburg, Ill., USA; the ARM processor and TEGRA System on a Chip (SoC) processors manufactured by Nvidia of Santa Clara, Calif., USA; the POWER7 processor manufactured by International Business Machines of White Plains, N.Y., USA; any of the FX, Phenom, Athlon, Sempron, or Opteron processors manufactured by Advanced Micro Devices of Sunnyvale, Calif., USA; or the Snapdragon SoC processors manufactured by Qalcomm of San Diego, Calif., USA.
A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.
In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.
Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.
The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.
“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then {
    prepare for rain;
} else {
    prepare for sunshine;
}
```

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.
“Text Search Rule(s)” generally refers to a rule coded with one or more preconditions configured to indicate when a sequence of characters is present in machine encoded text. A text search rule may be triggered when the machine encoded text includes an exact match for a specified character sequence such as a word or series of words. The order of the sequence may be determinative as well. A text search rule may also be triggered when the text to be searched is “close” to the text in the rule. A target “closeness” threshold value may be encoded in the rule so that matches that are less than the target value do not trigger the rule, while matches equal to or greater than the target value will trigger the rule.
Examples of matching techniques or algorithms include a native string search text search rule. A native string search is satisfied when a string of characters may be found that matches the exact positioning of letters or specific series of letters in one or more words. For example, a native string search rule may include a comparison between machine encoded text and a specific character string such as “order”, “patient”, “order number”, “SSN”, “MRN”, or “physician order” and the like. The rule may only be triggered when at least one of these character strings appears in the machine encoded text.
Another example a Deterministic Finite Automaton (DFA) may be constructed to recognize a stored search string or “pattern” to match against a string of text. An example of this kind of search rule is a regular expression matched against machine encoded text using a regular expression engine. Rules with such encoded expressions may include multiple expression strings with Boolean operators indicating the inclusion of “and”, “or”, “not” and other logical expressions. These and other strings in the matching expression may indicate how often certain characters may appear, in what order relative to one another, and/or whether and what kind of white space may be included, to name a few non-limiting examples. Matching expressions indicating how the multiple character strings may match encoded text may be simple or complex.
In another example, a trigram search may be used which is designed to find a “closeness” score or “confidence level” between the search string and the text rather than a simple “match/non-match” result. Sometimes referred to as a “fuzzy” search, a trigram search rule is triggered when strings of characters match the maximum number of three-character strings in a set of search terms, i.e., near matches. A threshold can be specified as a cutoff point, after which a result is no longer regarded as a match. The closeness of a match may be measured in terms of the number of primitive operations necessary to convert the string into an exact match. This number is called the “edit distance” between the string and the pattern.
For example, an order text search rule may be implemented to provide a strength or confidence level for each specific rule indicating how closely a particular set of characters in the machine encoded text matches the order text specified in the rule. If the rule is searching for the word “order” and the word “physician” in any position in the encoded text, the rule may indicate a match with a 100% confidence level where an exact match for both words appear anywhere in the machine encoded text. The same rule may indicate a match with a 50% confidence level if the machine encoded text includes the word “order” but not the word “physician.” In another example, the rule may include a less than 50% confidence level if both “physician” and “order” do not appear, but similarly spelled words like “recorder”, “odor” or “older” are present, or similar sounding words like “mortar”, “hoarder”, or “rotor”.
In another example, specific rules may be configured to trigger when a string of characters is matched because it has a length that is between the predetermined maximum and minimum size, includes specific characters in a location in a string of characters. For example, one search rule may be configured to search for order numbers where rule searches the machine encoded text for 15 character strings where the first character is a capital “O”, and the last 12 characters in the string are numerical.
Any suitable criteria may be used to determine if the machine encoded text includes specific text strings. Any suitable search rule may be using the rules, including rules that rely on commercially available search algorithms such as algorithms provided by Google Inc., of Mountain View, Calif., USA, Yahoo! Inc., of Sunnyvale, Calif., USA, and Microsoft Corporation of Redmond, Wash., USA, and others.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method, comprising:
using the one or more processors to accept input defining at least one target document to include in a set of electronic documents, wherein the at least one target document is defined by a target document type associated with the target document;
controlling an automatic digitizing unit to automatically digitize multiple physical documents using one or more processors, wherein the digitizing unit is configured to generate multiple electronic documents that include digital copies of the multiple physical documents;
using the one or more processors to recognize symbols representing document data encoded in the digital copies of the physical documents, wherein the one or more processors are configured to generate machine encoded text corresponding to the symbols, and wherein the document data includes the document type associated with that individual document;
using the one or more processors to control the knowledge base to store the multiple electronic documents in the knowledge base as separate electronic records, wherein the separate electronic records correspond to the individual electronic documents of the multiple electronic documents, wherein the separate electronic records are identified by individual knowledge base identifiers, and wherein the document type included in the document data is associated with the individual electronic records in the knowledge base;
comparing the document type of individual electronic documents of the multiple electronic documents to the at least one target document type using the one or more processors, wherein target documents from the multiple electronic documents matching the at least one target document type are added to the set of electronic documents associated with an individual patient;
using the one or more processors to control the knowledge base to store the set of electronic documents associated with an individual patient in a knowledge base as a single electronic record, the single electronic record identifiable by an identifier that is different than the individual knowledge base identifiers associated with the multiple electronic documents; and
using the one or more processors to accept input identifying a set of electronic documents associated with an individual patient, wherein the one or more processors controls the knowledge base to retrieve the set of electronic documents.

2. The method of claim 1, further comprising:
comparing the document data encoded in the digital copies of the physical documents with one or more separator data rules using the one or more processors, wherein a separator rule is triggered when the document data corresponding to at least one physical document matches predetermined separator data indicating the at least one physical document is a separator document;
wherein the multiple physical documents include at least a first batch of one or more physical documents, and at least a second batch of one or more other physical documents;
wherein the separator document is between the first and second batches in the multiple physical documents when the multiple physical documents are digitized by the automatic digitizing unit; and
wherein the first batch of physical documents corresponds to a first set of electronic documents, and the second batch of physical documents corresponds to a second set of electronic documents.

3. The method of claim 1, further comprising:
comparing the document data encoded in the digital copies of the physical documents with one or more patient data rules using the one or more processors, wherein a patient data rule is triggered when the document data corresponding to at least one physical document matches predetermined patient data indicating the patient that a physical document is associated with;
wherein the multiple physical documents include at least a first batch of one or more physical documents with data about a first patient included therein, and at least a second batch of one or more other physical documents with data about a second patient included therein; and
wherein the first batch of physical documents corresponds to a first set of electronic documents associated with the first patient in the knowledge base, and the second batch of physical documents corresponds to a second set of electronic documents associated with a second patient in the knowledge base.

4. The method of claim 1, further comprising:
comparing the document data to one or more document type search rules using the one or more processors, wherein a document type search rule is triggered when the document data matches one of a predetermined set of one or more document types;
wherein the matching document type matched by the triggered document type search rule is associated with the document data.

5. The method of claim 4, comprising:
calculating a document confidence level using the document data and the one or more processors, wherein the document confidence level indicates the likelihood that the document type is one of the predetermined set of one or more document types;

6. The method of claim 5, comprising:
generating a low confidence indicator using the one or more processors, wherein the low confidence indicator indicates that the document confidence level is below a predetermined target value;
using the one or more processors to control a display device to generate a user interface on the display device, the user interface including controls configured to confirm or deny that the document type associated with the document data for a corresponding physical document includes a document type that is one of the predetermined set of document types.

7. The method of claim 1, wherein documents from the multiple electronic documents not matching at least one of the predetermined set of one or more document types are not added to the set of electronic documents.

8. A method, comprising:
using one or more processors to control an automatic digitizing unit coupled to the one or more processors, wherein the digitizing unit is configured to accept multiple physical documents, and wherein the digitizing unit generates multiple electronic documents that include digital copies of the multiple physical documents;
using the one or more processors to recognize symbols representing document data encoded in the digital copies of the physical documents, wherein the one or more processors are configured to generate machine encoded text corresponding to the symbols, and wherein the machine encoded text includes a document type;
using the one or more processors to control the knowledge base to store the multiple electronic documents in the knowledge base as separate electronic records, wherein the separate electronic records correspond to the individual electronic documents of the multiple electronic documents, wherein the separate electronic records are identified by individual knowledge base identifiers, and wherein the individual electronic records are associated with the at least one corresponding document type in the knowledge base;
after the multiple electronic documents are stored in the knowledge base, using the one or more processors to accept input defining at least one target document to include in a set of electronic documents, wherein the at least one target document is defined by a target document type associated with the target document;
using the one or more processors to accept input defining at least one target patient;
using one or more processors to control the knowledge base to retrieve one or more electronic documents associated with the target patient, wherein the one or more electronic documents include a document type matching the at least one target document type;
creating a set of electronic documents that includes the one or more electronic documents using the one or more processors;
controlling the knowledge base using the one or more processors to store the set of electronic documents associated with the target patient in a knowledge base as a single electronic record; and
using the one or more processors to accept input identifying a set of electronic documents associated with an individual patient, wherein the one or more processors controls the knowledge base to retrieve the set of electronic documents.

9. The method of claim 8, further comprising:
comparing the document data encoded in the digital copies of the physical documents with one or more separator data rules using the one or more processors, wherein a separator rule is triggered when the document data corresponding to at least one physical document matches predetermined separator data indicating the at least one physical document is a separator document;
wherein the multiple physical documents include at least a first batch of one or more physical documents, and at least a second batch of one or more other physical documents;
wherein the separator document is between the first and second batches in the multiple physical documents when the multiple physical documents are digitized by the automatic digitizing unit; and
wherein the first batch of physical documents corresponds to a first set of electronic documents, and the second batch of physical documents corresponds to a second set of electronic documents.

10. The method of claim 8, further comprising:
comparing the machine document data encoded in the digital copies of the physical documents with one or more patient data rules using the one or more processors, wherein a patient data rule is triggered when the document data corresponding to at least one physical document matches predetermined patient data indicating the patient that a physical document is a associated with;
wherein the multiple physical documents include at least a first batch of one or more physical documents with a first patient data included therein, and at least a second batch of one or more other physical documents with a second patient data included therein; and
wherein the first batch of physical documents corresponds to a first set of electronic documents associated with the first patient in the knowledge base, and the second batch of physical documents corresponds to a second set of electronic documents associated with a second patient in the knowledge base.

11. The method of claim 8, further comprising:
comparing the document data to one or more document type search rules using the one or more processors, wherein a document type search rule is triggered when the document data matches one of a predetermined set of one or more document types;
wherein the matching document type matched by the triggered document type search rule is associated with the document data.

12. The method of claim 11, comprising:
calculating a document confidence level using the document data and the one or more processors, wherein the document confidence level indicates the likelihood that the document type is one of the predetermined set of one or more document types;

13. The method of claim 12, comprising:
generating a low confidence indicator using the one or more processors, wherein the low confidence indicator indicates that the document confidence level is below a predetermined target value;
using the one or more processors to control a display device to generate a user interface on a display device, the user interface including controls configured to confirm or deny that the document type associated with the document data for a corresponding physical document includes a document type that is one of the predetermined set of document types.

14. A system, comprising:
one or more computers having one or more processors and at least one memory;
a patient knowledge base;
a computer network coupling the one or more computers to the patient knowledge base;
an automatic digitizing unit controlled by the one or more processors, wherein the automatic digitizing unit is configured to accept a physical document and generate an electronic document that includes a digital copy of the physical document, the digital copy including document data;
a text recognition module that configures the one or more processors to recognize symbols representing readable characters in the digital document and generate machine encoded text corresponding to the readable characters;
a user interface module that configures the one or more processors to accept target document input defining at least one target document identified by a target document type associated with the target document to include in a set of electronic documents, and/or target patient input defining a target patient the at least one target document is associated with, the target patient input corresponding to a target patient identifier;
a document type module that configures the one or more processors to compare the machine encoded text to one or more document type search rules, wherein the one or more processors triggers a document type search rule when the machine encoded text includes document type text;
a batch recognition module that configures the one or more processors to separate multiple digital copies of corresponding physical documents in to one or more sets of electronic documents;
a document processing module that configures the one or more processors to calculate a document confidence level, wherein the document confidence level indicates the likelihood that the document includes a document type that is one of a set of predetermined document types; and
a knowledge base module that configures the one or more processors to control the patient knowledge base to store and retrieve the one or more sets of electronic documents.

15. The system of claim 14, wherein the batch recognition module is configured to compare the document data encoded in the digital copies of the physical documents with one or more separator data rules using the one or more processors, wherein a separator rule is triggered when the document data corresponding to at least one physical document matches predetermined separator data indicating the at least one physical document is a separator document;
wherein the multiple physical documents include at least a first batch of one or more physical documents, and at least a second batch of one or more other physical documents;
wherein the separator document is between the first and second batches in the multiple physical documents when the multiple physical documents are digitized by the automatic digitizing unit; and
wherein the first batch of physical documents corresponds to a first set of electronic documents, and the second batch of physical documents corresponds to a second set of electronic documents.

16. The system of claim 14, comprising:
a patient text search module that configures the one or more processors to compare the machine encoded text to one or more patient text search rules, wherein the one or more processors triggers a patient text search rule when the machine encoded text includes patient text identifying a patient;
wherein the patient text search module is configured to compare the document data encoded in the digital copies of the physical documents with one or more patient data rules using the one or more processors;
wherein a patient data rule is triggered when the document data corresponding to at least one physical document matches predetermined patient data indicating the patient that a physical document is associated with;
wherein the multiple physical documents include at least a first batch of one or more physical documents with a first patient data included therein, and at least a second batch of one or more other physical documents with a second patient data included therein; and
wherein the patient text search module communicates with the batch recognition module, the batch recognition module configured to store a first batch of electronic documents corresponding to a first set of physical documents associated with the first patient in the knowledge base, and a second batch of electronic documents corresponding to a second set of physical documents associated with a second patient in the knowledge base.

17. The system of claim 14, comprising
an input device coupled to the one or more processors and configured to accept input from a user, wherein the interface module configures the one or more processors to accept input from the input device verifying that one or more electronic documents are including in a set of electronic documents.

18. The system of claim 14, wherein the user interface module configures the one or more processors to control a visual display device to display a user interface;
wherein the user interface includes a low confidence indicator, and visual controls configured to accept input from a user specifying the document type for an electronic document; and
wherein the document processing module configures the one or more processors to generate a low confidence indicator in the user interface when the document confidence level is below a predetermined target value.

19. The method of claim 14, wherein the document processing module is configured to compare the document data to one or more document type search rules using the one or more processors, wherein a document type search rule is triggered when the document data matches one of a predetermined set of one or more document types.

20. The system of claim 14, wherein the user interface module configures the one or more processors to accept input defining at least one target document type to include in a set of electronic documents;
wherein the user interface module configures the one or more processors to accept input defining at least one target patient;
wherein the knowledge base module configures the one or more processors to control the knowledge base to retrieve one or more individual electronic documents associated with the target patient, wherein the one or more electronic documents include a document type matching the at least one target document type; and
wherein the batch recognition module configures the one or more processors to create a new set of electronic documents that includes the one or more electronic documents previously digitized by the automatic digitizing unit; and
wherein the knowledge base module configures the one or more processors to control the knowledge base to store the new set of electronic documents in the knowledge base.
